(19) United States
(12) Patent Application Publication
(10) Pub. No.: US 2020/0339801 A1
(43) Pub. Date: Oct. 29, 2020

(54) COMPOSITIONS OF RESIN AND MESH OR MESH-LIKE MATERIALS

(71) Applicant: ACS International Products, L.P., Tucson, AZ (US)

(72) Inventors: Jean Alvarado, Tucson, AZ (US); John Simmons, Tucson, AZ (US); Kay Rehberg, Tucson, AZ (US)

(21) Appl. No.: 16/393,726

(22) Filed: Apr. 24, 2019

(51) Int. Cl. C08L 67/00

(52) U.S. Cl. CPC C08L 67/00; C08L 2205/16

(57) ABSTRACT

Compositions of resin and a mesh or mesh-like material wherein the material is less than 10% by weight of the finished composition. In some embodiments, the mesh or mesh-like material in the compositions are non-homogenous and discontinuous. Some embodiments include not more than 3% by weight of tissue paper as the mesh or mesh-like material, while others utilize an order of magnitude less.

### FIELD OF THE INVENTION

The disclosure herein is directed to resin compositions and in particular those resin compositions comprising a plurality of discontinuous pieces of non-homogeneous and mesh-like materials.

### BACKGROUND OF THE INVENTION

Paper has been used in the manufacturing of composites for years as a method of recycling paper. For example, cut paper can be compressed with a binder resin to made denser blocks of scrap paper that are easier to transport to a paper making facility that forms the blocks into new paper.

Another example involves a method of producing dry-process paper board for structural panels, whereby a mixture of 70% cut paper can be compressed with a synthetic resin to make structural parts.

While compositions that combine a large amount/high percentage of paper have utility and provide a market for recycling of paper, the finished compositions may have issues ranging from less desirable aesthetics, to higher production cost, to having physical properties that are inferior to the same finished products that do not do incorporate paper.

### SUMMARY OF THE DISCLOSURE

In certain embodiments, this disclosure relates to compositions of resin and a mesh or mesh-like material wherein the material is non-homogenous, discontinuous (e.g., in pieces or flakes) and comprises less than 10% by weight of the finished composition.

In further embodiments, the compositions of resin and mesh-like material comprise 3% or less by weight of the finished composition. In still other embodiments, the compositions of resin and mesh-like material comprises 1% or less by weight of the finished composition, for example, about 0.6%, about 0.3%, or about 0.1% (wherein “about” means plus-or-minus 10% of a stated amount).

In many embodiments, the mesh-like material has a pore size of less than about 100 μm. In certain embodiments, the mesh can be fabrics (e.g., knitted, knotted, woven or synthesized). In other embodiments, the mesh may be cellulosic mesh-like material, such as various grades of paper including tissue paper.

For certain applications, embodiments may feature mesh sizes up to 1 mm as appropriate. The mesh or mesh-like material can be treated with a coating to change the color and to add properties such as fire resistance (for example by DOPO, ATH), durability (for example by quartz or dolomite) or bonding (for example by silanisation) in the resin matrix. Coatings that control electrostatic changes (e.g., quanternary ammonium compounds) and/or other electrical properties (e.g., conductive metals or insulating materials such as fiberglass) also are contemplated.

Still other embodiments include mesh and/or mesh-like material sized (in diameter) to be from one quarter inch (6.35 mm) to two inches (50.8 mm). In some applications, the size preferably is about one half inch (12.7 mm) to 0.039 inch (1 mm).

These and other aspects will be further described in the drawing and detailed description presented below. However, the claims are not intended to be limited to the embodiments and examples described herein.

### BRIEF DESCRIPTION OF THE DRAWINGS

The embodiments will be better understood from a reading of the following detailed description taken in conjunction with the drawings in which like reference designators are used to designate like elements, and in which:

FIG. 1 depicts a resin composition that contains a particulate material described as “platinum flake” (polyester flakes).

FIG. 2 depicts a resin composition that contains a mesh or mesh-like material (tissue paper).

FIG. 3 depicts a resin composition that contains paint flakes.

### DETAILED DESCRIPTION OF THE PREFERRED EMBODIMENTS

The disclosure herein is described in preferred embodiments in the following specification with reference to the Figures. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used herein, “mesh” or “mesh-like material” means a material having a structural arrangement that provides openings through the material. Non-limiting examples of mesh include those made of metal (e.g., wire screen), plastics, or fabrics. Non-limiting examples of “mesh-like material” include cellulosic materials, including paper products (e.g., processed paper pulp such as tissue paper).

Moreover, as used herein, “discontinuous” pieces of mesh or mesh-like materials means the pieces are not more than 10% contiguous in the final composition, while non-homogeneous means not more than 10% homogeneity in the mesh or mesh-like materials.

In some embodiments, the mesh or mesh-like material comprises or consists essentially of processed wood pulp, such as tissue paper. For the embodiments in which the mesh or mesh-like material consists essentially of tissue paper, it has been found that a more equally distributed pattern of flakes throughout the resin (and at the surface of a set resin) can be achieved.

Furthermore, the flakes from tissue paper have been found to have more rounded edges than other types of flaked material, which may cause the tissue paper flakes to handle better than flakes with sharper edges (e.g., disaggregate more thoroughly, fewer flakes getting caught on equipment or storage bags, etc.). Moreover, the structural strength of the resin may be improved through the addition of tissue paper flakes. While not intending to limit any such improvements to a particular mechanism of action, the structural integrity or strength may be improved because the resin absorbs into the tissue paper mesh structure.

In further embodiments, at least 25% of the discontinuous and non-homogeneous mesh or mesh-like material is smooth or rounded (i.e., not sharp or angular) at an edge of the material. In other embodiments, at least 50% of the discontinuous and non-homogeneous mesh or mesh-like material is smooth or rounded at an edge of the material.

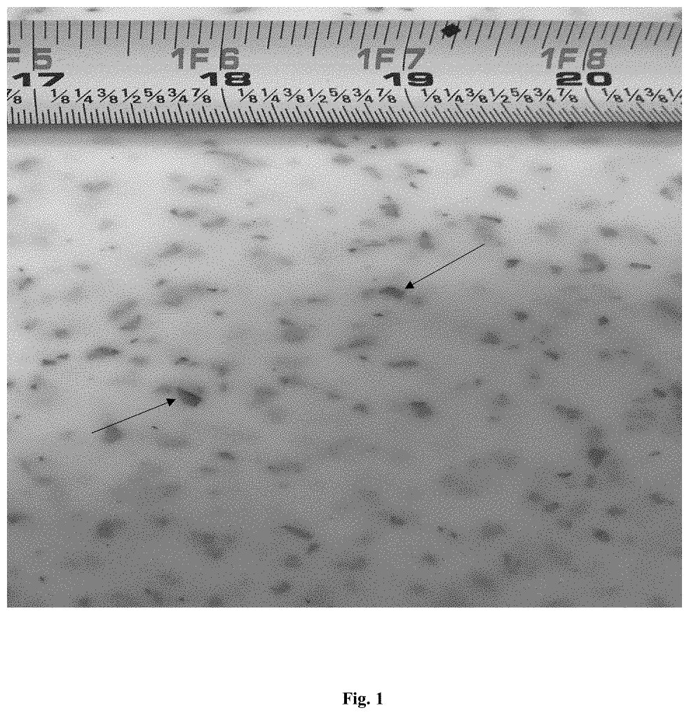

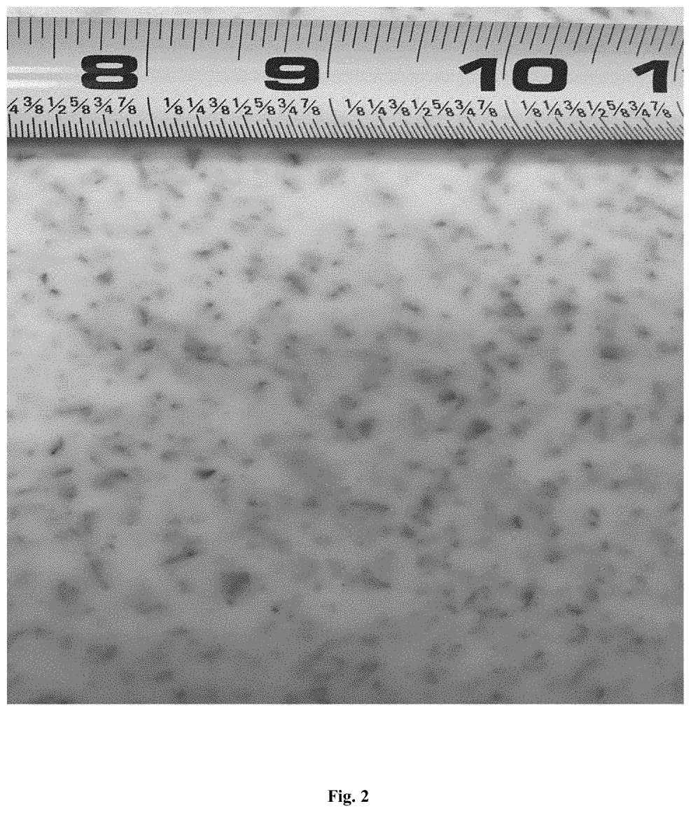

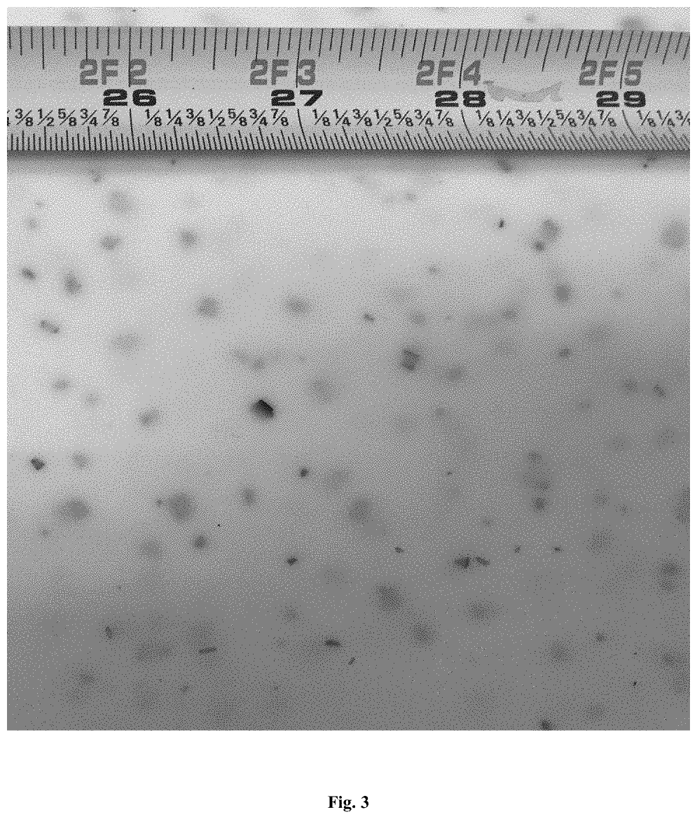

FIG. 1 depicts a resin composition that contains a porous particulate material (polyester flakes) that are light and porous. As signified by the arrows, on average, these flakes tend to have “sharp” (more angular and less rounded) edges in comparison to the tissue paper flakes shown in the resin of FIG. 2. In addition, more tissue paper flakes can be used because they are lighter than, for example, the paint flakes shown in the resin of FIG. 3.

In some embodiments, the mesh or mesh-like material is tissue paper in an amount less than 5% by weight of the finished resin composition. The mesh or mesh-like material any of the embodiments may take the form of flakes. In other embodiments, 0.3% by weight of tissue paper has been found to produce a thoroughly distributed pattern of flakes in a finished resin product in comparison to the same weight of other porous flake materials, which can result in cost savings and other benefits.

Depending on the embodiment, the mesh or mesh-like material has a porosity of 1 mm to less than 100 μm. Moreover, the mesh material can treated with a coating to change the color (e.g., pigment addition), to add properties such as fire resistance (for example by 9,10-Dihydro-9-oxa-10-phosphaphenanthrene 10-Oxide [DOPO] or aluminum trihydrate), to increase durability (for example by addition of quartz and/or dolomite), or even bonding (for example by silanisation) in the resin matrix.

The addition of a coating to the mesh or mesh-like material (e.g., tissue paper) prior to flaking can affect how the material breaks apart. For example, sheets of tissue paper coated with silicate emulsion paints, epoxy-, polyester- or acrylic resins, etc., can enable one to then press a pattern into one or more sheets with the result that the sheet(s) break in a predetermined way (a pattern) suitable for a particular use. Thus, embodiments herein relate to methods of forming resin composition that contain flakes of material formed into a predetermined pattern.

The following examples are presented to further illustrate to persons skilled in the art how to make and use the embodiments herein. These examples are not intended as a limitation, however, upon the scope of the claims.

### Example I

Table 1 below shows a chart of each component of a resin composition a mesh material, for example, tissue paper, with the amount of each by weight of the total composition.

| Polyester | Polyester | | | Calcium | | |
|---|---|---|---|---|---|---|
| Casting | Clear Gel | Mesh | | Carbon- | Alumina | |
| Resin | Coat | Material | Granules | ate | Trihydrate | Total |
| 30.3 | | 0.7 | | 69 | | 100 |
| 26.6 | | 0.4 | | 73 | | 100 |
| 27 | | 1 | 12 | 60 | | 100 |
| 39 | | 0.5 | | | 60.5 | 100 |
| 36 | | 0.3 | | | 63.7 | 100 |
| 35 | | 1 | 12 | | 52 | 100 |
| | 99.4 | 0.6 | | | | 100 |
| | 86 | 0.3 | 13.7 | | | 100 |

### Example 2

Table 2 below shows a chart of each component of a resin composition containing a mesh material, for example, tissue paper, and other types of mesh materials (paint flakes and polyester “platinum flake”), with the amount of each by weight of the total composition.

| | Paint | ACS Platinum | Mesh |
|---|---|---|---|
| Ingredient | Flakes | Flake | Flakes |
| Polyester Resin | 36.8 | 36.8 | 36.8 |
| Alumina | 62.6 | 62.6 | 62.6 |
| Trihydrate | | | |
| TiO2 Pigment | 0.3 | 0.3 | 0.3 |
| Paint Flakes | 0.3 | 0 | 0 |
| ACS Platinum | 0 | 0.3 | 0 |
| Flake | | | |
| Mesh Flakes | 0 | 0 | 0.3 |
| Total | 100 | 100 | 100 |

### Example 3

A castable resin composition is made by mixing the following (all percentages are by weight): Onyx Pro 25 filler (25 um) at 60.90%, titanium dioxide pigment at 0.3%, flaked tissue paper at 0.3%, SIL94BA-1581 dual purpose marble resin at 37.6%, M-50A catalyst at 0.6% (which is ˜1.5% of the resin weight), and additional minifibers (such as Minifiber ESSSF from Pacific Coast Chemicals, etc.) at 0.3%.

The described features, structures, or characteristics of the invention may be combined in any suitable manner in one or more embodiments. In the above description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. In other words, the present invention may be embodied in other specific forms without departing from its spirit or essential characteristics. The described implementations are to be considered in all respects only as illustrative and not restrictive. The scope of the invention should, therefore, be determined not with reference to the above description, but instead should be determined with reference to the pending claims along with their full scope or equivalents, and all changes which come within the meaning and range of equivalency of the claims are to be embraced within their full scope.

We claim:

1. A composition, comprising a plurality of one or both of pieces of mesh or mesh-like material disposed in a resin, wherein the composition comprises less than 10% by weight of the mesh or mesh-like material.

2. The composition of claim 1, wherein the resin is translucent and organic or inorganic.

3. The composition of claim 1, further comprising a filler selected from the group consisting of aluminum trihydrate, calcium carbonate, gypsum, pigments, or conductive particles.

4. The composition of claim 1, wherein the pieces of mesh or mesh-like material are discontinuous and non-homogeneous after being mixed in the composition.

5. The composition of claim 4, wherein at least 25% of the discontinuous and non-homogeneous mesh or mesh-like material is smooth or rounded at an edge of said material.

6. The composition of claim 2, wherein the resin is selected from the group consisting of polyester, epoxy, methyl methacrylate, polyurea, and water glass.

7. The composition of claim 4, wherein at least 50% of the discontinuous and non-homogeneous mesh or mesh-like material is smooth or rounded at an edge of said material.

8. The composition of claim 1, wherein pieces of mesh or mesh-like material comprise processed wood pulp.

9. The composition of claim 8, wherein the wood pulp comprises tissue paper.

10. The composition of claim 9, wherein the resin is translucent and organic or inorganic.

11. The composition of claim 9, further comprising a filler selected from the group consisting of aluminum trihydrate, calcium carbonate, gypsum, pigments, or conductive particles.

12. The composition of claim 9, wherein the pieces of mesh or mesh-like material are discontinuous and non-homogeneous after being mixed in the composition.

13. The composition of claim 12, wherein at least 25% of the discontinuous and non-homogeneous mesh or mesh-like material is smooth or rounded at an edge of said material.

14. The composition of claim 9, wherein the resin is selected from the group consisting of polyester, epoxy, methyl methacrylate, polyurea, and water glass.

15. The composition of claim 12, wherein at least 50% of the discontinuous and non-homogeneous mesh or mesh-like material is smooth or rounded at an edge of said material.

16. The composition of claim 1, wherein said pieces of mesh or mesh-like material further comprise a coating.

17. The composition of claim 9, wherein the tissue paper has a size ranging from is ¼ inch to 2 inches.

18. The composition of claim 9, wherein the tissue paper has a porosity of 100 μm or less.

19. A method of forming a resin composition, comprising the step of:
adding mesh or mesh-like material to a resin, wherein the amount of said material is between 0.3% to 4% by weight.

20. The method of claim 19, wherein said mesh or mesh-like material comprises tissue paper.

21. The method of claim 20, further comprising the step of coating and disaggregating said tissue paper into a predetermined shape or shapes prior to adding to said resin.
